(19) United States
(12) Patent Application Publication
(10) Pub. No.: US 2026/0124958 A1
(43) Pub. Date: May 7, 2026

(54) SYSTEM AND METHOD FOR BATTERY COOLING

(71) Applicant: Ford Global Technologies, LLC, Dearborn, MI (US)

(72) Inventor: Xiaogang Zhang, Novi, MI (US)

(21) Appl. No.: 18/938,828

(22) Filed: Nov. 6, 2024

(51) Int. Cl. B60L 58/26; B60K 11/02; H01M 10/613; H01M 10/625; H01M 10/63; H01M 10/6568

(52) U.S. Cl. CPC B60L 58/26; B60K 11/02; H01M 10/613; H01M 10/625; H01M 10/63; H01M 10/6568; H01M 2220/20

(57) ABSTRACT

Systems and methods cooling battery cells of a battery are described. The system may include a plurality of spool valves to create a plurality of coolant flow paths through a battery pack so that a temperature differential between battery cells may be reduced. A controller adjusts positions of the spool valves according to battery cell temperature.

### FIELD

The present description relates to methods and a system for cooling a battery pack that is comprised of a plurality of battery cells. In one example, the battery pack may be installed in an electric vehicle.

### BACKGROUND AND SUMMARY

An electric vehicle may include a traction battery for propelling a vehicle. The traction battery may be comprised of a plurality of battery cells. The plurality of battery cells may include battery cells that are arranged in parallel and in series. The temperature of these battery cells may increase during charging and/or discharging of the battery cells. In order to provide long battery life and charge capacity it may be desirable to keep each battery cell at a temperature that is equal to temperatures of the other battery cells. In other words, it may be desirable to operate battery cells of a battery with as little temperature difference across the plurality of battery cells as may be possible. In an example, a method for controlling battery pack temperature, comprises, via one or more controllers, adjusting a first valve position to direct coolant flow to one of a plurality of battery pack coolant inlets in response to a battery cell temperature.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic view of an example electric vehicle;

FIG. 2 is a schematic perspective view of an example battery pack is shown;

FIG. 3 shows plots of example battery cell temperatures in the battery pack of FIG. 2;

FIG. 4 shows a schematic view of an example battery cooling system;

FIGS. 5A-5C show a cut-away view of an inlet spool valve in three different operating states;

FIGS. 5D-5F show a cut-away view of an outlet spool valve in three different operating states;

FIGS. 6A-6E show different operating modes for the battery cooling system of FIG. 4;

FIG. 7 shows a flowchart of a method for operating the battery cooling system of FIG. 4; and

FIG. 8 shows a flowchart of a second method for operating the battery cooling system of FIG. 4.

### DETAILED DESCRIPTION

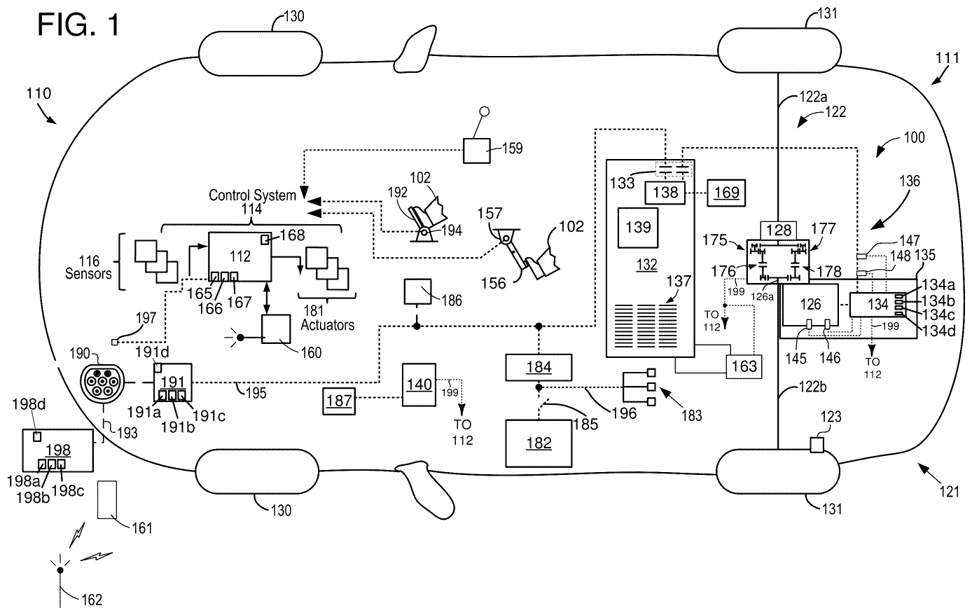

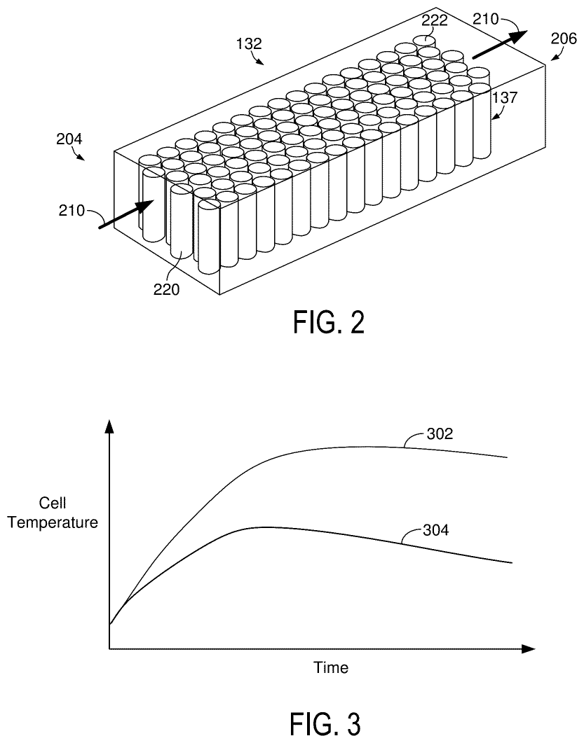

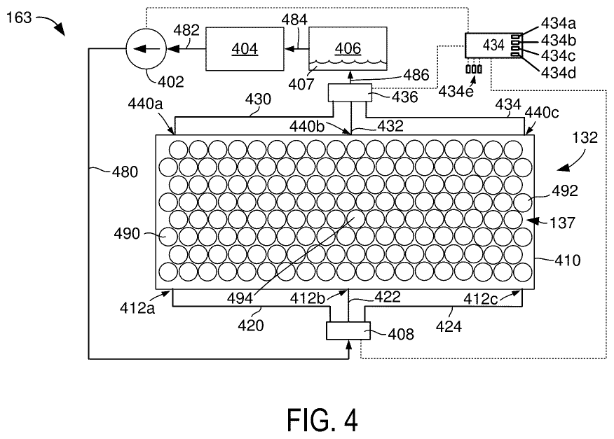

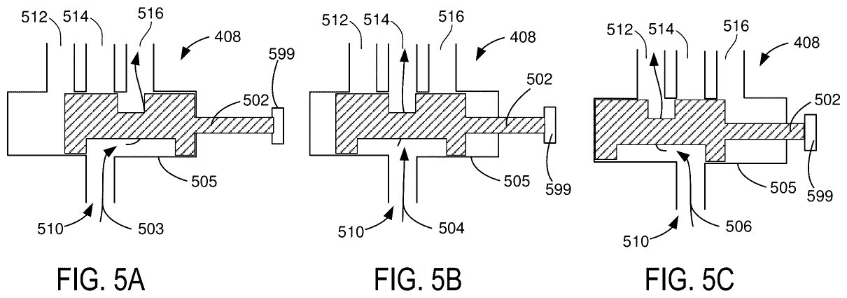

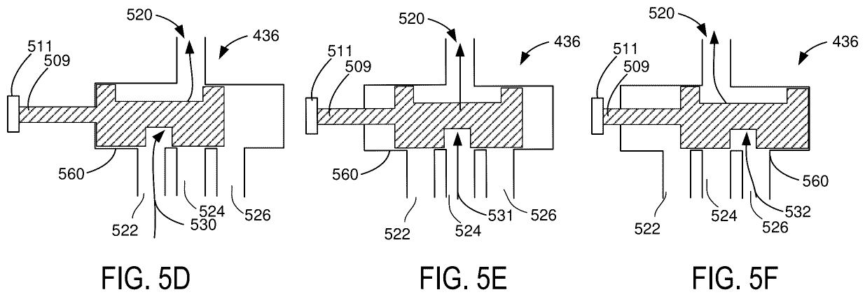

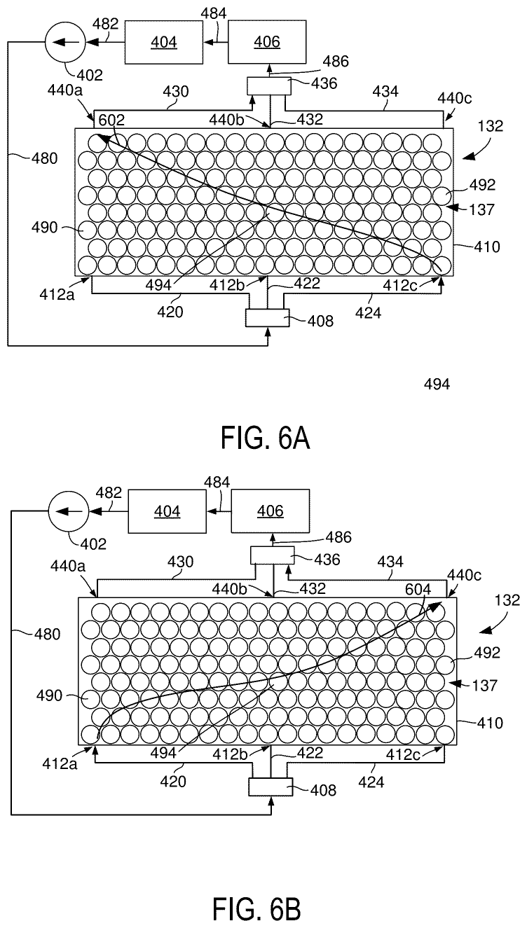

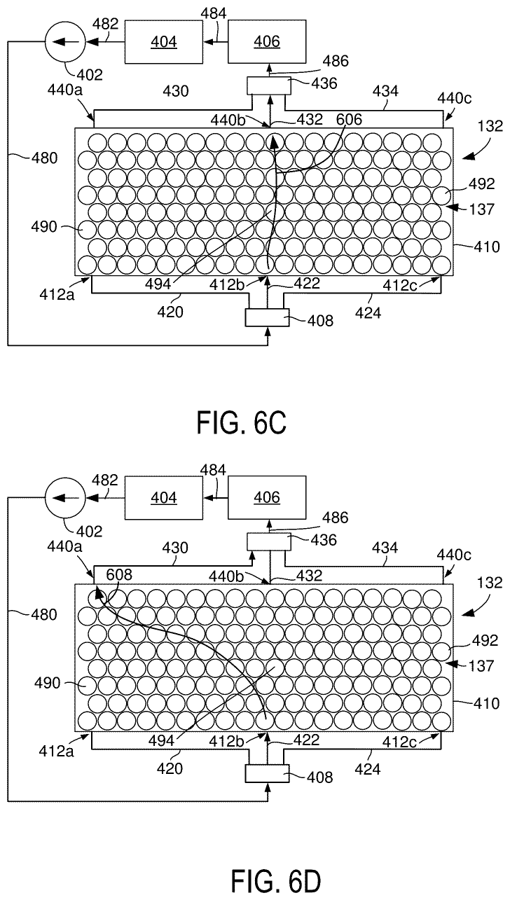

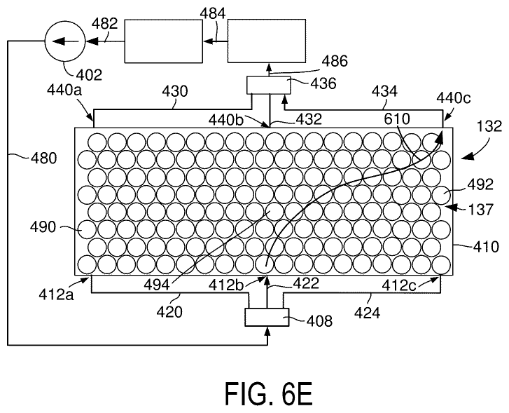

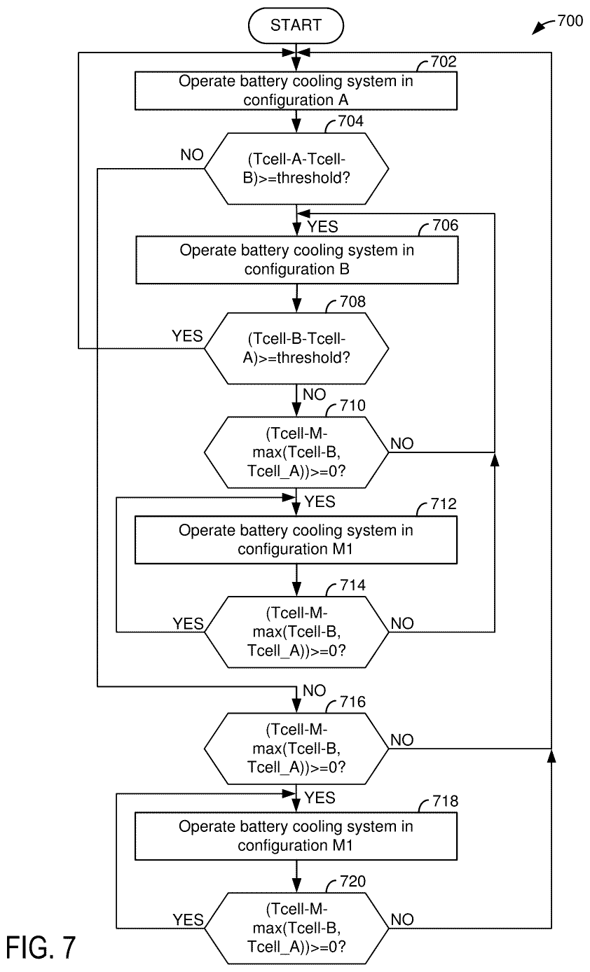

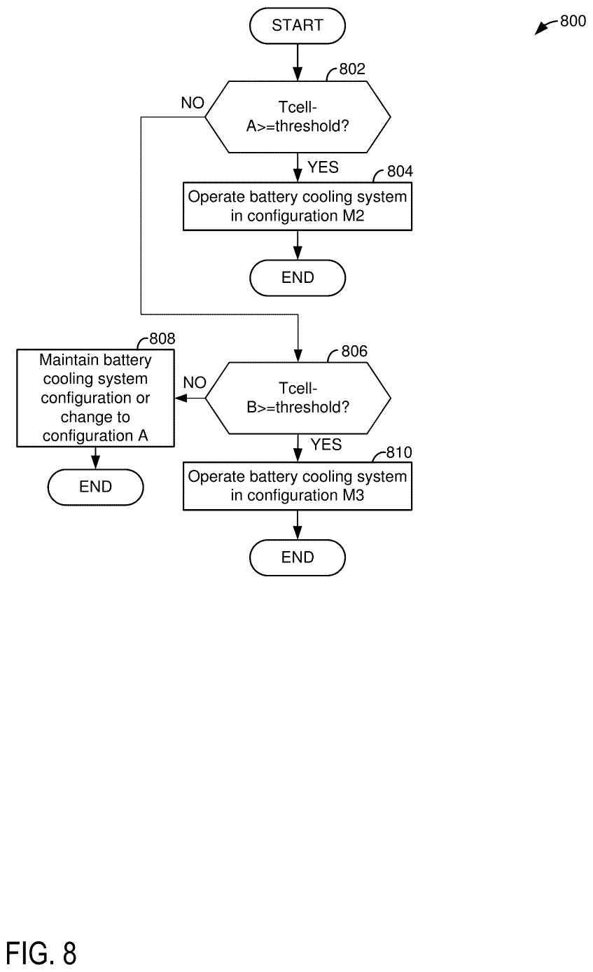

The present description is related to a cooling system for a battery pack that is comprised of a plurality of battery cells. The cooling system may include two spool valves that control flow of coolant into and out of the battery pack. The cooling system also includes a controller and a control routine to lower differential temperature within the battery pack. The battery pack may be included in an electric vehicle as shown in FIG. 1. FIG. 2 shows an example coolant flow path through an example battery pack and FIG. 3 shows battery cell temperature profiles for battery cells shown in FIG. 2. A battery pack coolant system according to the present description is shown in FIG. 4. Various positions of coolant flow control valves are shown in FIGS. 5A-5F. Several coolant flow control modes for the coolant system of FIG. 4 are shown in FIGS. 6A-6E. A method for operating the battery pack cooling system of FIG. 4 is shown in FIG. 7. A second method for operating the battery pack cooling system of FIG. 4 is shown in FIG. 8.

Battery cells within a battery may be cooled or heated to be maintained at a desirable temperature. Operating the battery cells at or near the desired temperature may extend battery life and permit desirable rates of charging and discharging of the battery cells. To maintain the battery cells at or near the desired temperature, a battery pack temperature control system may be applied. The battery pack temperature control system, which may be referred to as a battery pack cooling system, may apply a heat exchanger to extract heat from the battery pack by flowing coolant past battery cells. This arrangement works well to maintain battery cells near a desired temperature and battery pack temperature control system enhancements may provide additional advantages for controlling battery cells to a desired temperature.

The inventor herein has recognized the above-mentioned issue and has developed a method for controlling battery pack temperature, comprising: via one or more controllers, adjusting a first valve position to direct coolant flow to one of a plurality of battery pack coolant inlets in response to a battery cell temperature.

By adjusting a first valve position to direct coolant flow to one of a plurality of battery pack coolant inlets in response to a battery cell temperature, it may be possible to reduce a temperature difference between battery cells of a battery pack. For example, it may be possible to control a temperature of a battery cell that is near a coolant outlet of a battery pack so that it is closer to a temperature of a battery cell that is near a coolant inlet of the battery pack. Consequently, charge capacities and life expectancies of battery cells within a battery pack may be maintained to be more uniform.

The present description may provide several advantages. In particular, the approach may provide extend battery pack life. Further, the approach may provide for more equal charge distribution between battery cells so that battery cells may deliver larger amounts of charge to electrical power consumers. Additionally, the approach may provide a way for battery cells to receive higher rates of charge for longer amounts of time so that battery charging time may be reduced.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

FIG. 1 is a block diagram of an example vehicle propulsion system 100 for vehicle 121. A front portion of vehicle 121 is indicated at 110 and a rear portion of vehicle 121 is indicated at 111. Vehicle propulsion system 100 includes electric machine 126. Electric machine 126 may consume or generate electrical power depending on its operating mode. Throughout FIG. 1, mechanical connections between various components are illustrated as solid lines, whereas electrical connections between various components are illustrated as dashed lines.

Vehicle propulsion system 100 includes a rear axle 122. In some examples, rear axle 122 may comprise two half shafts, for example first half shaft 122a, and second half shaft 122b. Vehicle propulsion system 100 further has front wheels 130 and rear wheels 131. Rear wheels 131 may be driven via electric machine 126.

The rear axle 122 is coupled to electric machine 126. Rear drive unit 136 may transfer power from electric machine 126 to axle 122 resulting in rotation of rear wheels 131. Rear drive unit 136 may include a low gear 175 and a high gear 177 that are coupled to electric machine 126 via output shaft 126a of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over controller area network (CAN) 199. Alternatively, high gear clutch 178 and low gear clutch 176 may be opened and closed via digital outputs or pulse widths provided via control system 114. Rear drive unit 136 may include differential gears 128 so that torque may be provided to first half shaft 122a and to second half shaft 122b. In some examples, an electrically controlled differential clutch (not shown) may be included in rear drive unit 136.

Electric machine 126 may receive electrical power from onboard electrical energy storage device (e.g. a traction battery or battery pack) 132. Furthermore, electric machine 126 may provide a generator function to convert the vehicle's kinetic energy into electrical energy, where the electrical energy may be stored at electric energy storage device 132 for later use by electric machine 126. An inverter system controller 134 (ISC1) may convert alternating current generated by electric machine 126 to direct current for storage at the electric energy storage device 132 and vice versa. Electric drive system 135 includes electric machine 126 and inverter system controller 134. Electric energy storage device 132 may be a battery, capacitor, inductor, or other electric energy storage device. Electric power flowing into electric drive system 135 may be monitored via current sensor 145 and voltage sensor 146. Position and speed of electric machine 126 may be monitored via position sensor 147. Torque generated by electric machine 126 may be monitored via torque sensor 148.

Electric machine 126 may propel vehicle 121 in a forward direction or reverse direction in response a position of shift selector 159. Further, vehicle 121 may enter park (e.g., no vehicle movement with vehicle wheels locked) or neutral in response to a position of shift selector 159.

In some examples, electric energy storage device 132 may be configured to store electrical energy that may be supplied via a high voltage bus 195 (e.g., components such as conductors that carry electric current and high voltage (e.g., voltage greater than 60 volts)). High voltage bus 195 may be in electrical communication with high voltage vehicle accessories (e.g., heat pump, air conditioner, heater, etc.) 186 and power converter 191 (e.g., direct current (DC) to DC converter or alternating current (AC) to DC converter). Power converter 191 is electrically coupled to electrical receptacle 190 and electrical receptacle 190 may be electrically coupled to an external charging station 198 (e.g., a direct current fast charger (DCFC), level 2 charger (e.g., a 240 volt alternating current charger), or a level 1 charger (e.g., 120 volt alternating current charger)) via cord 193. External charging station 198 includes non-transitory (e.g., read exclusive memory) 198a, random access memory 198b, digital inputs/outputs 198c, and a microcontroller 198d. Power converter 191 may control electric current flow and voltage supplied to electric energy storage device 132. Power converter 191 may include a non-transitory (e.g., read exclusive memory) 191a, random access memory 191b, digital inputs/outputs 191c, and a microcontroller 191d. Receptacle sensor 197 provides an indication of whether or not vehicle 121 is plugged in to the external charging station 198. External charging station 198 resides external to the vehicle (e.g., not part of the vehicle). High voltage bus 195 may also be electrically coupled to a DC/DC converter 184, which allows electric power to be transferred from high voltage bus 195 to low voltage bus 196 (e.g., conductors, terminals, and other conductive linking devices). Thus, electric power may be exchanged between electric energy storage device 132 and low voltage battery 182 (e.g., battery voltage of less than 20 volts). Low voltage battery switch 185 may be selectively opened to prevent power to low voltage battery 182 (e.g., 12 volts DC) from low voltage bus 196. Low voltage bus 196 may distribute low voltage electric power to low voltage electric loads 183 (e.g., electric power consumers such as infotainment system, windshield wipers, blowers, etc.).

Returning to FIG. 1, electric energy storage device 132 includes a plurality of battery cells 137, an electric energy storage device controller 139, and a power distribution module 138. Electric energy storage device controller 139 may provide charge balancing between energy storage element (e.g., battery cells) and communication with other vehicle controllers (e.g., controller 112). Power distribution module 138 controls flow of power into and out of electric energy storage device 132. A contactor 133 may selectively couple and decouple electric energy storage device 132 to high voltage bus 195 and inverter system controller (ISC1) 134. In some examples, contactor 133 may be located external to the electric energy storage device 132. Power distribution module 138 is also shown directly electrically coupled to protected DC/DC converter 169.

Electric energy storage device temperature control system 163 (e.g., a heat pump or heat exchanger) may include a temperature control actuator 164 (e.g., a pump, valve, electric switch, etc.) to adjust a temperature of electric energy storage device. Electric energy storage device temperature control system 163 may receive a requested electric energy storage device temperature via a controller that is coupled to CAN 199.

Control system 114 may communicate with electric machine 126, energy storage device 132, navigation system 187, etc. Control system 114 may receive sensory feedback information from electric drive system 135 and electric energy storage device 132, etc. Further, control system 114 may send control signals to electric drive system 135 and electric energy storage device 132, etc., responsive to this sensory feedback. Control system 114 may receive an indication of an operator requested output of the vehicle propulsion system from a human operator 102, or an autonomous controller. For example, control system 114 may receive sensory feedback from pedal position sensor 194 which communicates with pedal 192. Pedal 192 may refer schematically to a driver demand pedal. Similarly, control system 114 may receive an indication of an operator (e.g., user) requested vehicle slowing via a human operator 102, or an autonomous controller. For example, control system 114 may receive sensory feedback from pedal position sensor 157 which communicates with vehicle caliper control pedal 156.

One or more wheel speed sensors (WSS) 123 may be coupled to one or more wheels of vehicle propulsion system 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 123, etc. In some examples, sensors associated with electric machine 126, wheel speed sensor 123, etc., may communicate information to controller 112, regarding various states of electric machine operation. Controller 112 includes non-transitory (e.g., read exclusive memory) 165, random access memory 166, digital inputs/outputs 168, and a microcontroller 167. Controller 112 may receive input data and provide data to human/machine interface 140 via CAN 199. Additionally, controller 112 may send vehicle data and receive command instructions (e.g. a request to prepare the vehicle for extended storage) via transceiver 160 and remote device 161 (e.g., cell phone, tablet, or other remote wireless device). Remote device 161 may transmit commands and receive data via cellular or satellite network 162.

Referring now to FIG. 2, it shows a perspective see-though example battery pack. Battery pack 132 is shown with a plurality of battery cells 137. In this example, battery cells 137 are shown in a shape of a cylinder. Battery pack 132 includes a front side 204 and a rear side 206. In this example, coolant flows in the direction that is indicated by arrows 210. Thus, coolant flows from a front side to a rear side of battery pack 132. A first battery cell 220 is arranged near front side 204 of battery pack 132 and a second battery cell 222 near rear side 206 of battery pack 132. If coolant flows solely in the direction indicated by arrows 210, a temperature differential as shown in FIG. 3 may develop between first battery cell 220 and second battery cell 222.

Referring now to FIG. 3, plots of example battery cell temperature profiles are shown. Specifically, a plot of battery cell temperature versus time is shown and the plot includes two traces. First trace 302 represents a temperature of second battery cell 222 shown in FIG. 2 and second trace 304 represents a temperature of first battery cell 220 shown in FIG. 2. Thus, there is a temperature differential between first trace 302 and second trace 304. This temperature differential may occur when coolant flows into battery pack 132 as shown in FIG. 2. It may be desirable to reduce the temperature differential so that first trace 302 more closely follows trace 304.

Referring now to FIG. 4, a schematic view of an example electric energy storage device temperature control system 163 (e.g., a battery pack temperature control system) is shown. In this example, electric energy storage device temperature control system 163 includes an inlet spool control valve 408 and an outlet spool control valve 436 that are shown external to battery pack housing 410. However, in other examples, inlet spool control valve 408 and an outlet spool control valve 436 may be included within battery pack housing 410. Electric energy storage device temperature control system 163 also includes a coolant pump 402 for circulating battery coolant within battery cooling system 400, a chiller 404, a coolant reservoir 406, and conduits or passages 480-486. Coolant may flow through the conduits or passages in a direction that is indicated by the arrow heads. Chiller 404 may be fluidically coupled to a heat pump (not shown). Operation of electric energy storage device temperature control system 163 may be adjusted via temperature control system 434 which includes non-transitory memory 434a (e.g., read exclusive memory), random access memory 434b, digital inputs/outputs 434c, and a microcontroller 434d. Electric energy storage device temperature control system may receive temperature information in the form of data, voltage, or current via temperature sensors 434e.

A battery cell described as cell A is shown at 490. Battery cell A is shown on an end of a left side of electric energy storage device 132 (battery pack) and it is closer to an inlet side of the battery pack where the first, second, and third inlets are located than to the outlet side of the battery pack where first, second, and third outlets are located. The temperature control system 434 may monitor a temperature of cell A. A battery cell described as cell B is shown at 492. Battery cell B is shown on and end of a right side of electric energy storage device 132 (battery pack) and it is closer to an inlet side of the battery pack where the first, second, and third inlets are located than to the outlet side of the battery pack where first, second, and third outlets are located. The temperature control system 434 may monitor a temperature of cell B. A battery cell described as cell M is shown at 494. Battery cell M is shown half way between the left side and the right side of electric energy storage device 132 (battery pack) and it is about midway between the inlet side of the battery pack and the outlet side of the battery pack. The temperature control system 434 may monitor a temperature of cell M.

During operation as shown in FIGS. 5A-5F positions of inlet spool control valve 408 and outlet spool control valve 436 may be adjusted to control battery cell temperature and a direction of flow for coolant flowing through electric energy storage device 132. In a first position, inlet spool control valve 408 may direct coolant flow through first coolant inlet 412a of electric energy storage device 132. In a second position, inlet spool control valve 408 may direct coolant flow through second coolant inlet 412b of electric energy storage device 132. In a third position, inlet spool control valve 408 may direct coolant flow through third coolant inlet 412c of electric energy storage device 132. In a first position, outlet spool control valve 436 may direct coolant flow from a first coolant outlet 440a of electric energy storage device 132. In a second position, outlet spool control valve 436 may direct coolant flow through a second coolant outlet 440b of electric energy storage device 132. In a third position, outlet spool control valve 436 may direct coolant flow through a third coolant outlet 440c of electric energy storage device 132.

Coolant may flow from pump 402 to inlet spool control valve 408. Coolant exits inlet spool control valve 408 and flows into electric energy storage device 132. Coolant exits electric energy storage device 132 and it flows to outlet spool control valve 436. Coolant may flow from outlet spool control valve 436 to coolant reservoir 406. Coolant 407 may flow from coolant reservoir 406 to chiller 404 (e.g., a heat exchanger) before returning to pump 402 as indicated by the arrows that indicate the conduits or passages.

Referring now to FIGS. 5A-5C, a cross-section of inlet spool control valve 408 is shown in three different positions. The three different positions allow coolant flow through electric energy storage device 132 to be controlled. Inlet spool control valve 408 includes a spool valve 502, a body 505, and an actuator 599 (e.g., an electrically actuated solenoid). Inlet spool control valve 408 also include a sole inlet 510, a first outlet 512, a second outlet 514, and a third outlet 516. FIG. 5A shows inlet spool control valve 408 in a first position where coolant may flow from sole inlet 510 and through third outlet 516 via a first coolant flow path 503. Coolant may not flow through the first and second outlets when inlet spool control valve 408 is in the first position. FIG. 5B shows inlet spool control valve 408 in a second position where coolant may flow from sole inlet 510 and through second outlet 514 via a second current flow path 504. Coolant may not flow through the first and third outlets when inlet spool control valve 408 is in the second position. FIG. 5C shows inlet spool control valve 408 in a third position where coolant may flow from sole inlet 510 and through first outlet 512 via a third coolant flow path 506. Coolant may not flow through the second and third outlets when inlet spool control valve 408 is in the third position.

Referring now to FIGS. 5D-5F, a cross-section of outlet spool control valve 436 is shown in three different positions. The three different positions allow coolant flow out of electric energy storage device 132 to be controlled. Outlet spool control valve 436 includes a spool valve 509, a body 560, and an actuator 511 (e.g., an electrically actuated solenoid). Outlet spool control valve 436 also include a sole outlet 520, a first inlet 522, a second inlet 524, and a third inlet 526. FIG. 5D shows outlet spool control valve 436 in a first position where coolant may flow from first inlet 522 to the sole outlet 520 via first coolant flow path 530. Coolant may not flow through the second and third inlets when outlet spool control valve 436 is in the first position. FIG. 5E shows outlet spool control valve 436 in a second position where coolant may flow from second inlet 524 through sole outlet 520 via second coolant flow path 531. Coolant may not flow through the first and third inlets when outlet spool control valve 436 is in the second position. FIG. 5F shows outlet spool control valve 436 in a third position where coolant may flow from third inlet 526 and through sole outlet 520 via third coolant flow path 532. Coolant may not flow through the first and second inlets when outlet spool control valve 436 is in the third position.

Referring now to FIG. 6A, electric energy storage device temperature control system 163 is shown in configuration A where coolant flows as indicated by the conduit arrows. In this configuration, inlet spool control valve 408 is operated in its first position so that coolant flows from pump 402 into third coolant inlet 412c. Additionally, outlet spool control valve 436 is operated in its first position so that coolant flows from first coolant outlet 440a to reservoir 406.

Referring now to FIG. 6B, electric energy storage device temperature control system 163 is shown in configuration B where coolant flows as indicated by the conduit arrows. In this configuration, inlet spool control valve 408 is operated in its third position so that coolant flows from pump 402 into first coolant inlet 412a. Additionally, outlet spool control valve 436 is operated in its third position so that coolant flows from third coolant outlet 440c to reservoir 406.

Referring now to FIG. 6C, electric energy storage device temperature control system 163 is shown in configuration M1 where coolant flows as indicated by the conduit arrows. In this configuration, inlet spool control valve 408 is operated in its second position so that coolant flows from pump 402 into second coolant inlet 412b. Additionally, outlet spool control valve 436 is operated in its second position so that coolant flows from second coolant outlet 440b to reservoir 406.

Referring now to FIG. 6D, electric energy storage device temperature control system 163 is shown in configuration M2 where coolant flows as indicated by the conduit arrows. In this configuration, inlet spool control valve 408 is operated in its second position so that coolant flows from pump 402 into second coolant inlet 412b. Additionally, outlet spool control valve 436 is operated in its first position so that coolant flows from first coolant outlet 440a to reservoir 406.

Referring now to FIG. 6E, electric energy storage device temperature control system 163 is shown in configuration M3 where coolant flows as indicated by the conduit arrows. In this configuration, inlet spool control valve 408 is operated in its second position so that coolant flows from pump 402 into second coolant inlet 412b. Additionally, outlet spool control valve 436 is operated in its third position so that coolant flows from third coolant outlet 440c to reservoir 406.

Coolant flow paths in the configurations A, B, M1, M2, and M3 are indicated via arrows 602-610 in FIGS. 6A-6E. These coolant flow paths allow the different battery cells to cool at different rates according to battery cell temperatures.

The system of FIGS. 1-6E provides for a battery pack temperature control system, comprising: an inlet spool control valve; an outlet spool control valve; a plurality of coolant inlets; a plurality of coolant outlets; a plurality of battery cells; and one or more controllers including executable instructions stored in controller memory that cause the one or more controllers to adjust the inlet spool control valve and the outlet spool control valve in response to a temperature of one or more of the plurality of battery cells. In a first example, the system includes where the inlet spool control valve may be adjusted to three different positions to provide three different flow paths through the inlet spool control valve. In a second example that may include the first example, the system includes where the outlet spool control valve may be adjusted to three different positions to provide three different flow paths through the outlet spool control valve. In a third example that may include one or both of the first and second examples, the system includes where the inlet spool control valve is in fluidic communication with the plurality of coolant inlets. In a fourth example that may include one or more of the first through third examples, the system includes where the outlet spool control valve is in fluidic communication with the plurality of coolant outlets. In a fifth example that may include one or more of the first through fourth examples, the system includes where the plurality of battery cells are contained in a housing. In a sixth example that may include one or more of the first through fifth examples, the system further comprises additional executable instructions to operate the battery pack temperature control system in five different cooling configurations. In a seventh example that may include one or more of the first through sixth examples, the system includes where the five different cooling configurations are based on different positions of the inlet spool control valve and different positions of the outlet spool control valve.

The system of FIGS. 1-6E provides for a battery pack temperature control system, comprising: an inlet spool control valve; an outlet spool control valve; a plurality of coolant inlets; a plurality of coolant outlets; a coolant pump; a coolant reservoir; a plurality of battery cells enclosed in a housing; and one or more controllers including executable instructions stored in controller memory that cause the one or more controllers to adjust the inlet spool control valve and the outlet spool control valve to produce a plurality of different coolant flow paths through the housing. In a first example, the battery pack temperature control system further comprises additional instructions to adjust a speed of the coolant pump in response to a temperature of one of the plurality of battery cells. In a second example that may include the first example, the battery pack temperature control system includes where the plurality of coolant inlets are arranged along a first side of the enclosure. In a third example that may include one or both of the first and second examples, the battery pack temperature control system includes where the plurality of coolant outlets are arranged along a second side of the enclosure. In a fourth example that may include one or more of the first through third examples, the battery pack temperature control system further comprises a chiller, the chiller in fluidic communication with the coolant pump and the coolant reservoir.

Referring now to FIG. 7, a method for controlling a temperature of a battery pack is shown. At least portions of method 700 may be included as executable instructions stored in non-transitory memory of one or more controllers. Further, some portions of method 700 may be actions performed in the physical world via the one or more controllers and one or more actuators. Method 700 may be included in the systems of FIGS. 1 and 4.

At 702, method 700 operates the battery pack temperature control system in configuration A as shown in FIG. 6A. In configuration A, electric energy storage device temperature control system is operated with the inlet spool control valve 408 in a first position and the outlet spool control valve 436 in a third position so that coolant flows from third coolant inlet 412c (e.g., a right side coolant inlet) of the electric energy storage device to a first coolant outlet 440a as indicated by the arrows in FIG. 6A. This allows coolant to cool battery cells in a right to left direction. Additionally, method 700 may adjust a speed of a coolant pump in response to a battery cell temperature. Method 700 proceeds to 704.

At 704, method 700 judges whether or not a temperature of battery cell A minus a temperature of battery cell B is greater than or equal to a first threshold temperature. If so, the answer is yes and method 700 proceeds to 706. Otherwise, the answer is no and method 700 proceeds to 716.

At 706, method 700 operates the battery pack temperature control system in configuration B as shown in FIG. 6B. In configuration B, electric energy storage device temperature control system is operated with the inlet spool control valve 408 in a third position and the outlet spool control valve 436 in a first position so that coolant flows from first coolant inlet 412a (e.g., a left side coolant inlet) of the electric energy storage device to a third coolant outlet 440c as indicated by the arrows in FIG. 6B. This allows coolant to cool battery cells in a left to right direction. Additionally, method 700 may adjust a speed of a coolant pump in response to a battery cell temperature. Method 700 proceeds to 708.

At 708, method 700 judges whether or not a temperature of battery cell B minus a temperature of battery cell A is greater than or equal to a second threshold temperature. If so, the answer is yes and method 700 returns to 702. Otherwise, the answer is no and method 700 proceeds to 710.

At 710, method 700 judges whether or not a temperature of battery cell M minus a greater of the temperature of battery cell A or the temperature of battery cell B is greater than or equal to zero. If so, the answer is yes and method 700 proceeds to 712. Otherwise, the answer is no and method 700 returns to 706.

At 712, method 700 operates the battery pack temperature control system in configuration M as shown in FIG. 6C. In configuration M1, electric energy storage device temperature control system is operated with the inlet spool control valve 408 in a second position and the outlet spool control valve 436 in a second position so that coolant flows from second coolant inlet 412b (e.g., a middle coolant inlet) of the electric energy storage device to a second coolant outlet 440b as indicated by the arrows in FIG. 6C. This allows coolant to cool battery cells in a middle to middle flow direction. Additionally, method 700 may adjust a speed of a coolant pump in response to a battery cell temperature. Method 700 proceeds to 714.

At 714, method 700 judges whether or not a temperature of battery cell M minus a greater of the temperature of battery cell A or the temperature of battery cell B is greater than or equal to zero. If so, the answer is yes and method 700 returns to 712. Otherwise, the answer is no and method 700 returns to 706.

At 716, method 700 judges whether or not a temperature of battery cell M minus a greater of the temperature of battery cell A or the temperature of battery cell B is greater than or equal to zero. If so, the answer is yes and method 700 proceeds to 718. Otherwise, the answer is no and method 700 returns to 702.

At 718, method 700 operates the battery pack temperature control system in configuration M as shown in FIG. 6C. In configuration M1, electric energy storage device temperature control system is operated with the inlet spool control valve 408 in a second position and the outlet spool control valve 436 in a second position so that coolant flows from second coolant inlet 412b (e.g., a middle coolant inlet) of the electric energy storage device to a second coolant outlet 440b as indicated by the arrows in FIG. 6C. This allows coolant to cool battery cells in a middle to middle flow direction. Additionally, method 700 may adjust a speed of a coolant pump in response to a battery cell temperature. Method 700 proceeds to 720.

At 720, method 700 judges whether or not a temperature of battery cell M minus a greater of the temperature of battery cell A or the temperature of battery cell B is greater than or equal to zero. If so, the answer is yes and method 700 returns to 718. Otherwise, the answer is no and method 700 returns to 702.

Thus, the method of FIG. 7 provides for changing direction of coolant flow through a battery pack in response to temperatures of battery cells so that a differential temperature between battery cells may be reduced. Further, the method of FIG. 7 provides for changing which battery pack coolant inlets and outlets receive flowing coolant so that the differential temperature between battery cells may be reduced. These actions may extend battery cell life and current charging and discharging capacities.

Referring now to FIG. 8, a second method for controlling a temperature of a battery pack is shown. At least portions of method 800 may be included as executable instructions stored in non-transitory memory of one or more controllers. Further, some portions of method 800 may be actions performed in the physical world via the one or more controllers and one or more actuators. Method 800 may be included in the systems of FIGS. 1 and 4. Additionally, the method of FIG. 8 may run concurrently with the method of FIG. 7 and the actions of the method of FIG. 8 may take priority over the actions performed by the method of FIG. 7. For example, if one of steps 804 and 810 is executed, the method of FIG. 7 may perform no actions.

At 802, method 800 judges whether or not a temperature of battery cell A is greater than a third threshold temperature. If so, method 800 proceeds to 804. Otherwise, the answer is no and method 800 proceeds to 806.

At 804, method 800 operates the battery pack temperature control system in configuration M2 as shown in FIG. 6D. In configuration M2, electric energy storage device temperature control system is operated with the inlet spool control valve 408 in a second position and the outlet spool control valve 436 in a first position so that coolant flows from second coolant inlet 412b (e.g., a middle coolant inlet) of the electric energy storage device to a first coolant outlet 440a as indicated by the arrows in FIG. 6D. This allows coolant to cool battery cells on the left side of the battery pack with priority. Method 800 proceeds to exit.

At 806, method 800 judges whether or not a temperature of battery cell B is greater than a fourth threshold temperature. If so, method 800 proceeds to 810. Otherwise, the answer is no and method 800 proceeds to 808.

At 810, method 800 operates the battery pack temperature control system in configuration M3 as shown in FIG. 6E. In configuration M3, electric energy storage device temperature control system is operated with the inlet spool control valve 408 in a second position and the outlet spool control valve 436 in a third position so that coolant flows from second coolant inlet 412b (e.g., a middle coolant inlet) of the electric energy storage device to a third coolant outlet 440c as indicated by the arrows in FIG. 6E. This allows coolant to cool battery cells on the right side of the battery pack with priority. Method 800 proceeds to exit.

At 808, method 800 maintains the presently active configuration for electric energy storage device temperature control system 163 if the electric energy storage device temperature control system 163 was not recently operated in the M2 or M3 configuration. However, if the electric energy storage device temperature control system 163 was recently operated in the M2 or M3 configuration, then method 800 changes the electric energy storage device temperature control system 163 into configuration A. Method 800 proceeds to exit.

Thus, if a temperature of battery cell A exceeds a threshold, coolant flow to battery cell A is prioritized so that battery cell A may cool with priority. On the other hand, if a temperature of battery cell B exceeds a threshold, coolant flow to battery cell B is prioritized so that battery cell B may cool with priority.

Thus, the methods of FIGS. 7 and 8 provide for a method for controlling battery pack temperature, comprising: via one or more controllers, adjusting a first valve position to direct coolant flow to one of a plurality of battery pack coolant inlets in response to a battery cell temperature. In a first example, the method further comprises adjusting a second valve position to direct coolant flow from one of a plurality of battery pack coolant outlets in response to the battery cell temperature. In a second example that may include the first example, the method includes where the plurality of battery pack coolant inlets include a first coolant inlet, a second coolant inlet, and a third coolant inlet. In a third example that may include one or both of the first and second examples, the method includes where the plurality of battery pack coolant outlets include a first coolant outlet, a second coolant outlet, and a third coolant outlet. In a fourth example that includes one or more of the first through third examples, the method includes where the first valve position is a position of a spool valve. In a fifth example that includes one or more of the first through fourth examples, the method includes where the battery cell temperature is a difference in temperature between a first battery cell and a second battery cell. In a sixth example that includes one or more of the first through fifth examples, the method further comprises adjusting a speed of a coolant pump in response to the battery cell temperature.

The methods and routines disclosed herein may be stored as executable instructions in non-transitory memory and may be carried out by a system including the controller in combination with the various sensors and actuators. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the system, where the described actions are carried out by executing the instructions in a system including the various hardware components in combination with the electronic controller. One or more of the method steps described herein may be omitted if desired.

While various embodiments have been described above, it may be understood that they have been presented by way of example, and not limitation nor restriction. It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The technology may be used as a stand-alone, or used in combination with other power transmission systems not limited to machinery and propulsion systems for tandem axles, electric tag axles, P4 axles, HEVs, BEVs, agriculture, marine, motorcycle, recreational vehicles and on and off highway vehicles, as an example. The subject matter of the present disclosure includes all novel and non-obvious combinations and sub-combinations of the various systems and configurations, and other features, functions, and/or properties disclosed herein. It will be apparent to persons skilled in the relevant arts that the disclosed subject matter may be embodied in other specific forms without departing from the spirit of the subject matter.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure. As used herein, the term “approximately” is construed to mean plus or minus five percent of the range, unless otherwise specified.

1. A method for controlling battery pack temperature, comprising:
via one or more controllers, adjusting a first valve position to direct coolant flow to one of a plurality of battery pack coolant inlets in response to a battery cell temperature.

2. The method of claim 1, further comprising adjusting a second valve position to direct coolant flow from one of a plurality of battery pack coolant outlets in response to the battery cell temperature.

3. The method of claim 2, where the plurality of battery pack coolant inlets include a first coolant inlet, a second coolant inlet, and a third coolant inlet.

4. The method of claim 3, where the plurality of battery pack coolant outlets include a first coolant outlet, a second coolant outlet, and a third coolant outlet.

5. The method of claim 1, where the first valve position is a position of a spool valve.

6. The method of claim 1, where the battery cell temperature is a difference in temperature between a first battery cell and a second battery cell.

7. The method of claim 1, further comprising adjusting a speed of a coolant pump in response to the battery cell temperature.

8. A battery pack temperature control system, comprising:
an inlet spool control valve;
an outlet spool control valve;
a plurality of coolant inlets;
a plurality of coolant outlets;
a plurality of battery cells; and
one or more controllers including executable instructions stored in controller memory that cause the one or more controllers to adjust the inlet spool control valve and the outlet spool control valve in response to a temperature of one or more of the plurality of battery cells.

9. The battery pack temperature control system of claim 8, where the inlet spool control valve may be adjusted to three different positions to provide three different flow paths through the inlet spool control valve.

10. The battery pack temperature control system of claim 9, where the outlet spool control valve may be adjusted to three different positions to provide three different flow paths through the outlet spool control valve.

11. The battery pack temperature control system of claim 8, where the inlet spool control valve is in fluidic communication with the plurality of coolant inlets.

12. The battery pack temperature control system of claim 8, where the outlet spool control valve is in fluidic communication with the plurality of coolant outlets.

13. The battery pack temperature control system of claim 8, where the plurality of battery cells are contained in a housing.

14. The battery pack temperature control system of claim 8, further comprising additional executable instructions to operate the battery pack temperature control system in five different cooling configurations.

15. The battery pack temperature control system of claim 14, where the five different cooling configurations are based on different positions of the inlet spool control valve and different positions of the outlet spool control valve.

16. A battery pack temperature control system, comprising:
an inlet spool control valve;
an outlet spool control valve;
a plurality of coolant inlets;
a plurality of coolant outlets;
a coolant pump;
a coolant reservoir;
a plurality of battery cells enclosed in a housing; and
one or more controllers including executable instructions stored in controller memory that cause the one or more controllers to adjust the inlet spool control valve and the outlet spool control valve to produce a plurality of different coolant flow paths through the housing.

17. The battery pack temperature control system of claim 16, further comprising additional instructions to adjust a speed of the coolant pump in response to a temperature of one of the plurality of battery cells.

18. The battery pack temperature control system of claim 16, where the plurality of coolant inlets are arranged along a first side of the housing.

19. The battery pack temperature control system of claim 18, where the plurality of coolant outlets are arranged along a second side of the housing.

20. The battery pack temperature control system of claim 16, further comprising a chiller, the chiller in fluidic communication with the coolant pump and the coolant reservoir.
